(19) United States
(12) Patent Application Publication
(10) Pub. No.: US 2014/0224616 A1
(43) Pub. Date: Aug. 14, 2014

(54) MONEY HANDLING APPARATUS

(71) Applicant: GLORY LTD., Himeji-shi, Hyogo-ken (JP)

(72) Inventors: Kazuhiro Doi, Himeji-shi (JP); Masatsugu Yokotani, Himeji-shi (JP); Keishi Kobayashi, Himeji-shi (JP)

(73) Assignee: GLORY LTD., Himeji-shi, Hyogo-ken (JP)

(21) Appl. No.: 14/345,959

(22) PCT Filed: Sep. 21, 2012
(86) PCT No.: PCT/JP2012/074157

§ 371 Date: Mar. 20, 2014

(30) Foreign Application Priority Data
Sep. 27, 2011 (JP) 2011-210814

(51) Int. Cl. G07D 11/00

(52) U.S. Cl. CPC G07D 11/0084
USPC 194/217

(57) ABSTRACT

The money handling apparatus of the present invention includes: a control unit configured to calculate a total amount of money having been put into an inlet by a customer so as to be taken into an apparatus body; and a medium outlet configured to dispense a medium outside the apparatus body, the medium storing or recording information enabling a value corresponding to the total amount of money having been calculated by the control unit to be specified. Based on a dispensing instruction given to the control unit, the money stored in storing units is dispensed, as much as needed, outside the apparatus body from an outlet.

### TECHNICAL FIELD

The present invention relates to a money handling apparatus configured to handle money composed of banknotes and coins. In particular, the present invention relates to a money handling apparatus capable of sorting and storing by denomination money that have been put into an apparatus body by a customer himself/herself in order to obtain a voucher or the like, and capable of dispensing the money according to need.

### BACKGROUND ART

It has been conventionally known that a voucher issuing machine is installed on a store such as a supermarket and so on (see, for example, JP9-512655T (WO95/30215A1) etc.). A voucher issuing machine disclosed in this patent document and so on is installed in an entrance of a store, a customer service area thereof and so on. The voucher issuing machine is configured to, when a customer puts thereinto a coin(s), issue a voucher, such as a cash voucher or the like, which has a value corresponding to a total amount of the coin(s) having been put thereinto. In a store where such a voucher issuing machine is installed, a customer firstly puts a coin(s) in hand into the voucher issuing machine so that a voucher is issued. Thereafter, when paying for an article(s) in the store, the customer passes the voucher to a clerk at a settlement corner so as to settle the article(s) in exchange for the voucher. The coin(s) having been put into the voucher issuing machine by the customer is stored in an apparatus body. Then, after opening hours of the store, an operator or the like of an armored car company manually collects the coin(s) in the apparatus body.

### SUMMARY OF THE INVENTION

Since the voucher issuing machine disclosed in the above patent document and so on cannot dispense a coin(s) which has been put into the apparatus body by a customer and stored in the apparatus body, the voucher issuing machine has a problem in that the coin(s) stored in the apparatus body thereof cannot be effectively used. In addition, in order to reduce fees to be paid to the armoured car company, it is desired for the store to decrease the number of times at which an operator or the like of the armored car company collects the coin(s) stored in the apparatus body of the voucher issuing machine.

The present invention has been made in view of the above circumstances. The object of the present invention is to provide a money handling apparatus capable of sorting and storing by denomination money, which has been put into an apparatus body by a customer himself/herself in order to obtain a voucher or the like, and capable of dispensing the money according to need, whereby the money having been put into the apparatus body can be effectively used by recycling, and the number of times at which an operator or the like of an armoured car company collects the money stored in the apparatus body can be decreased.

The present invention is a money handling apparatus to be installed in a store, the money handling apparatus including: an inlet which a customer puts money therein; a recognition unit configured to recognize and count money having been put into the inlet so as to be taken into an apparatus body; a plurality of storing units configured to store, by denomination, money having been recognized and counted by the recognition unit; a control unit configured to calculate a total amount of the money having been put into the inlet by a customer so as to be taken into the apparatus body, based on a recognition result by the recognition unit; a medium outlet configured to dispense a medium outside the apparatus body, the medium storing or recording information for identifying a value corresponding to the total amount of the money having been calculated by the control unit; and an outlet configured to dispense money outside the apparatus body; wherein based on a dispensing instruction given to the control unit, the money stored in the storing units is dispensed, as much as needed, outside the apparatus body from the outlet.

According to such a money handling apparatus, there is provided the inlet into which a customer himself/herself is capable of putting money, and a total amount of the money having been put into the inlet by a customer so as to be taken into the apparatus body is calculated by the control unit. In addition, the medium storing or recording the information enabling the value corresponding to the total amount of the money having been calculated by the control unit to be specified, specifically, a voucher such as a cash voucher, for example, is dispensed from the medium outlet. Further, based on the dispensing instruction given to the control unit, money stored in the respective storing units is dispensed, as much as needed, outside the apparatus body from the outlet. According to such a money handling apparatus, the money having been put into the apparatus body by the customer in order to obtain a voucher or the like can be dispensed, whereby the money having been put into the apparatus body of the money handling apparatus can be effectively used by recycling, and the number of times at which an operator or the like of an armoured car company collects the money stored in the apparatus body can be decreased.

In the money handling apparatus of the present invention, the medium may be: a voucher that can be used in the store in which the money handling apparatus is installed; a voucher that can be used in a company other than the store in which the money handling apparatus is installed; an IC card in which information related to the total amount of the money calculated by the control unit is written; an IC card in which a serial number, which corresponds to the total amount of money calculated by the control unit, of a host server in which the total amount is written; or a paper sheet in which the serial number is described.

In the money handling apparatus of the present invention, when the money handling apparatus is provided in a settlement corner, the control unit may be configured to execute any one of a settlement mode in which a settlement process is performed, and a charge mode in which money is deposited into the apparatus body and the information enabling a value corresponding to a total amount of the deposited money to be specified is stored or recorded in the medium, and the dispensing instruction given to the control unit may be an instruction for dispensing money as change in the settlement mode.

At this time, the dispensing instruction given to the control unit may be an instruction for dispensing money in a cash-out process when a debit card is received from a customer.

In addition, at this time, the inlet, the medium outlet and the outlet may be located on a side of a customer, whereby a customer has access to them.

Alternatively, the money handling apparatus may be provided in a customer service area, and the dispensing instruction given to the control unit may be an instruction for dispensing money as change funds to be replenished into a register system installed in a settlement corner.

At this time, the money may be dispensed to an interface cassette through the outlet, the interface cassette being respectively detachable to the register system and the money handling apparatus.

In addition, the money may be dispensed to a drawer of the register system through the outlet.

In addition, the inlet and the medium outlet may be located on a side of a customer, whereby a customer has access to them; and the outlet may be located in a service counter of the customer service area, whereby a customer is incapable of accessing the outlet.

In the money handling apparatus of the present invention, the dispensing instruction may be given from a higher-level apparatus to which the money handling apparatus is communicably connected.

According to the money handling apparatus of the present invention, the money that has been put into the apparatus body by a customer himself/herself in order to obtain a voucher or the like can be sorted and stored by denomination and can be dispensed according to need, whereby the money having been put into the apparatus body can be effectively used by recycling, and the number of times at which an operator or the like of an armoured car company collects the money stored in the apparatus body can be decreased.

### BRIEF DESCRIPTION OF THE DRAWINGS

FIG. 1 is a view showing a layout of a store in which a money handling apparatus in an embodiment of the present invention is installed;

FIG. 2 is a structural view showing a structure of a store system in which the money handling apparatus in the embodiment of the present invention is installed;

FIG. 3 is a view showing an appearance of the money handling apparatus shown in FIGS. 1 and 2;

FIG. 4 is a structural view showing an inside structure of a banknote handling apparatus in the money handling apparatus shown in FIG. 3, wherein FIG. 4(a) is a view showing a condition in which a banknote reception unit is mounted on an inlet unit, and FIG. 4(b) is a view showing a condition in which an interface cassette is mounted on the inlet unit;

FIG. 5 is a functional block view of the banknote handling apparatus shown in FIG. 4;

FIG. 6 is a side view schematically showing an inside structure of a coin handling apparatus in the money handling apparatus shown in FIG. 3;

FIG. 7 is a front view of the coin handling apparatus shown in FIG. 6; and

FIG. 8 is a functional block view of the coin handling apparatus shown in FIGS. 6 and 7.

### MODE FOR CARRYING OUT THE INVENTION

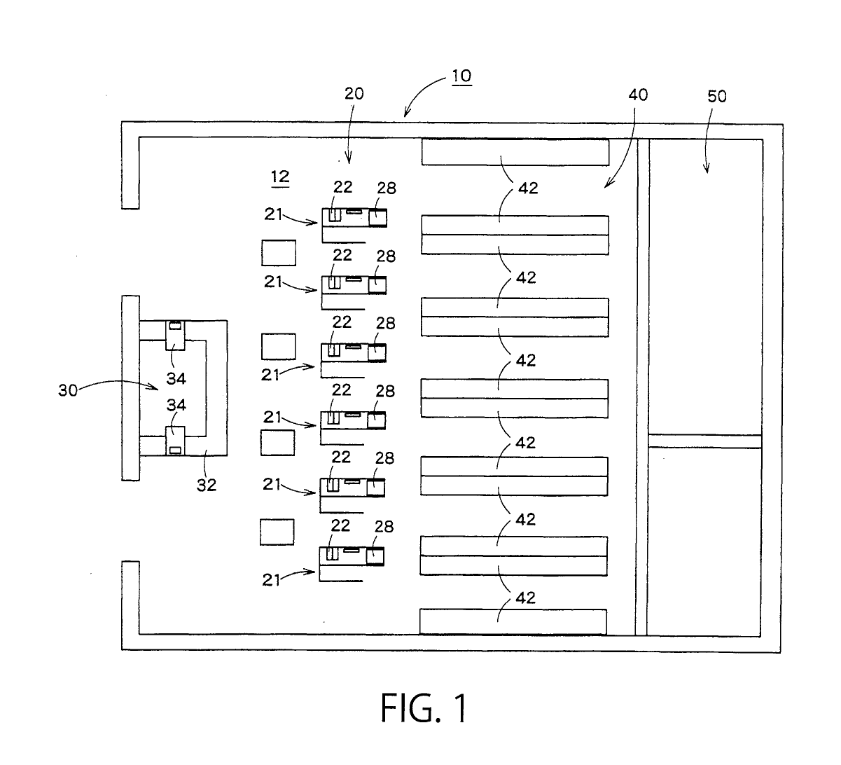

An embodiment of the present invention will be described herebelow with reference to the drawings. FIGS. 1 to 8 are views showing a money handling apparatus according to this embodiment and a store system including the money handling apparatus.

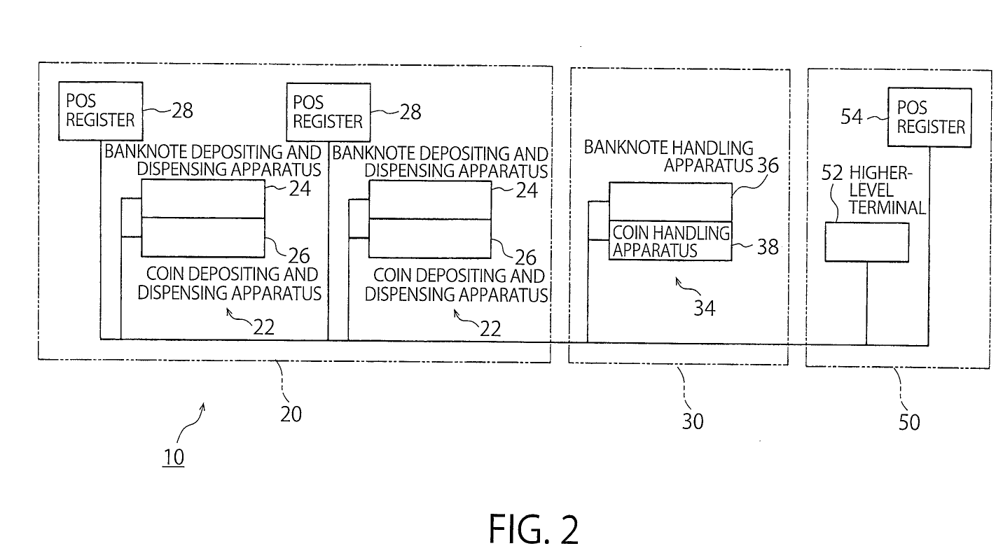

A layout of a store in which the money handling apparatus according to the embodiment of the present invention is installed is firstly explained with reference to FIG. 1. As shown in FIG. 1, a store 10 such as a supermarket is separated into a front area 12 where a customer can enter, and a back office 50 where a customer cannot enter. The front area 12 is composed of a settlement corner 20 in which a plurality of register systems 20 are provided, a customer service area 30, and an article rack area 40 in which a plurality of article racks 42 are provided for displaying articles. A customer takes out an article to be purchased from the article rack 42, and settles up a bill for the article (pays for the article) in the settlement corner 20. Each register system 21 of the settlement corner 20 is provided with a POS (Point-Of-Sale) register 28 and a money settlement apparatus 22. As shown in FIG. 2, the money settlement apparatus 22 is composed of a banknote depositing and dispensing apparatus 24 and a coin depositing and dispensing apparatus 26. The customer service area 30 is located near to an entrance of the store 10. A money handling apparatus 34 is installed in a service counter 32 of the customer service area 30. As shown in FIG. 2, the money handling apparatus 34 is composed of a banknote handling apparatus 36 and a coin handling apparatus 38.

In addition, an interface cassette 37 described below is detachably attached to the banknote handling apparatus 36. Cash (banknotes) is carried by means of the interface cassette 37 among the banknote handling apparatus 36 in the customer service area 30, the banknote depositing and dispensing apparatus 24 in the settlement corner 20, and the back office 50. When the interface cassette 37 is detached from the banknote handling apparatus 36 and the banknote depositing and dispensing apparatus 24, banknotes stored in the interface cassette 37 cannot be taken out therefrom.

In addition, a coin storing cassette 39 described below is detachably attached to the coin handling apparatus 38. Cash (coins) is carried by means of the coin storing cassette 39 among the coin handling apparatus 38 in the customer service area 30, the coin depositing and dispensing apparatus 26 in the settlement corner 20, and the back office 50.

A structure of the store system of the store 10 shown in FIG. 1 is explained with reference to FIG. 2. As shown in FIG. 2, the back office 50 is provided with a higher-level terminal 52. The higher-level terminal 52 is communicably connected to the POS registers 28 in the settlement corner 20, the money settlement apparatuses 22 therein, and the money handling apparatus 34 disposed in the customer service area 30.

In this manner, the higher-level terminal 52 is configured to transmit and receive various information to and from the POS registers 28 and the money settlement apparatuses 22 disposed in the settlement corner 20 and the money handling apparatus 34 disposed in the customer service area 30. In addition, a POS server 54 is installed in the back office 50. The POS server 54 is communicably connected to the higher-level terminal 52. The higher-level terminal 52 is configured to transmit and receive various information to and from the POS server 54.

In this embodiment, when a customer puts a banknote(s) and/or a coin(s) into the money handling apparatus 34 installed in the service counter 32 of the customer service area 30, the money handling apparatus 34 is configured to issue a voucher, such as a cash voucher or the like, which has a value corresponding to a total amount of money of the banknote(s) and the coin(s) having been put thereinto. The voucher such as a cash voucher or the like can be used in the store 10 in which the money handling apparatus 34 is installed. Thus, a customer coming to the store 10 firstly puts a banknote(s) and/or a coin(s) in hand into the money handling apparatus 34, so that a voucher is issued. Thereafter, when paying for an article(s) in the store 10, the customer passes the voucher to a clerk in the settlement corner 20 so that the customer can perform a settlement for the article(s) in exchange for the voucher. The banknote(s) and/or the coin(s) having been put into the money handling apparatus 34 by the customer are stored in an apparatus body. In addition, in this embodiment, the banknote(s) and the coin(s) stored in the money handling apparatus 34 can be dispensed. A banknote(s) and/or a coin(s) having been dispensed therefrom are replenished as change funds into the money settlement apparatus 22 installed in the settlement corner 20, or are transported to the back office 50 so as to be collected.

In addition, in this embodiment, as shown in FIG. 1, the money handling apparatus 34 has at least two side surfaces facing inside and outside the service counter 32. The side surface facing inside the service counter 32 is a surface on a side of a clerk in the service counter 32, while the side surface facing outside the service counter 32 is a surface on a side of a customer. Inlet openings of the money handling apparatus 34 are provided in the customer-side surface and the clerk-side surface, respectively. On the other hand, an outlet opening of the money handling apparatus 34 is provided only in the clerk-side surface. In addition, a printed-matter outlet opening 142a (described below) through which a voucher is dispensed outside the apparatus body faces the customer-side surface of the money handling apparatus 34.

The detailed structure of the money handling apparatus 34 is explained below.

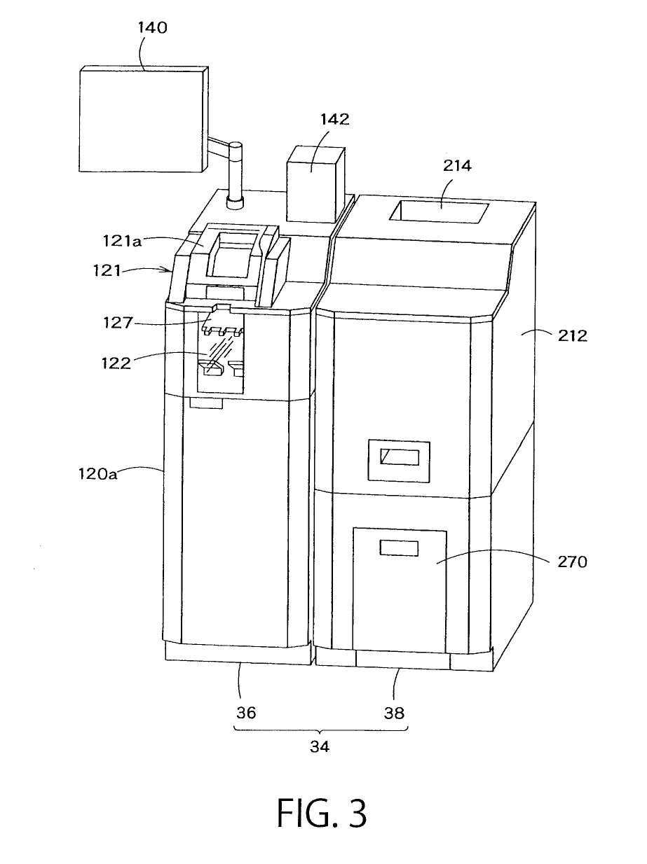

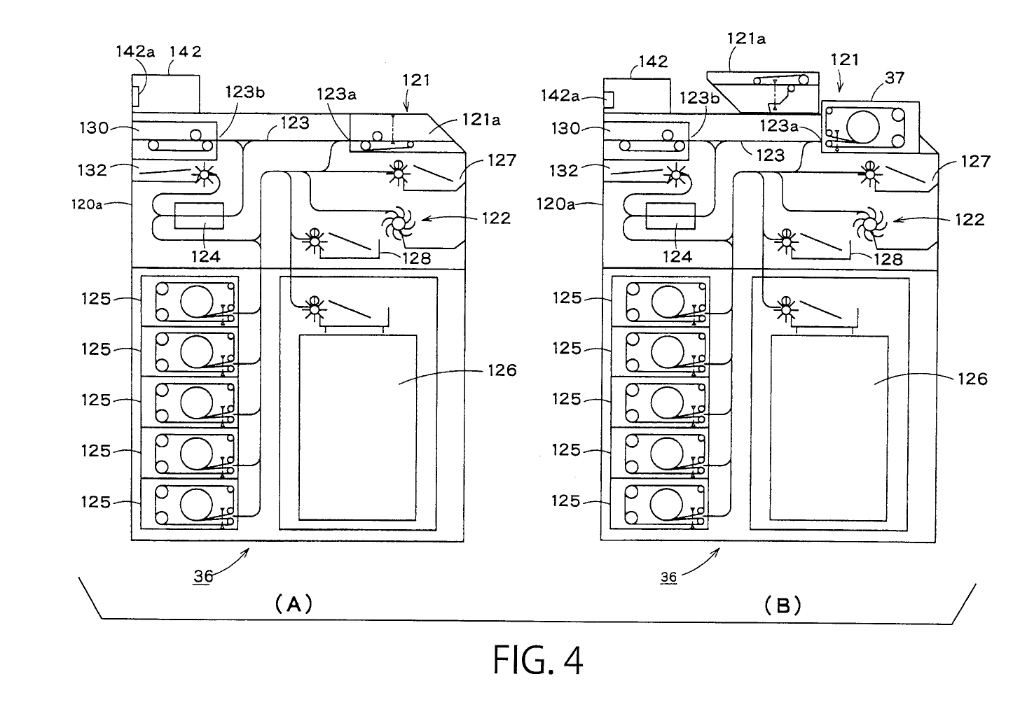

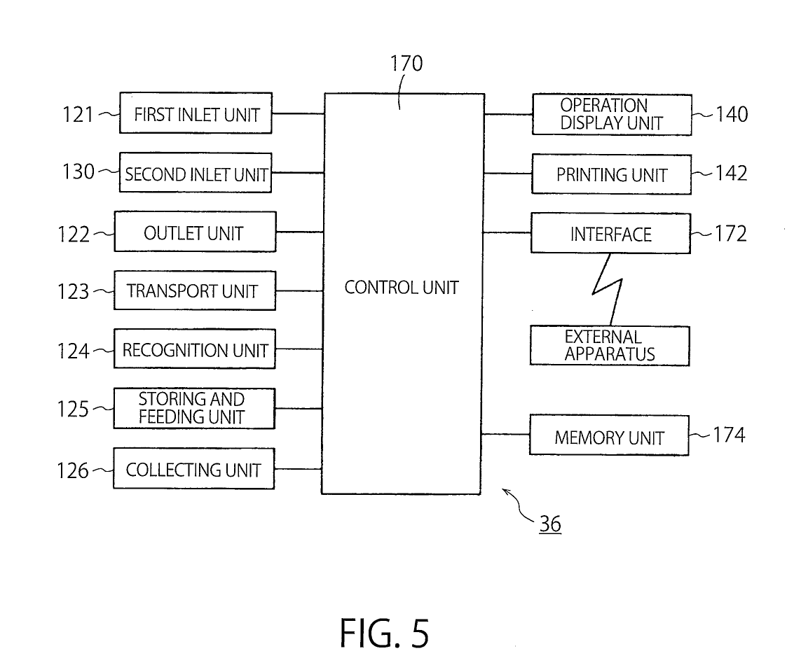

An appearance of the money handling apparatus 34 in this embodiment is shown in FIG. 3. The front surface of the money handling apparatus 34 shown in FIG. 3 faces the inside of the service counter 32 of the customer service area 30 shown in FIG. 1, i.e., the clerk side. In addition, FIG. 4 shows an inside structure of the banknote handling apparatus 36 in the money handling apparatus 34 shown in FIG. 3. FIG. 4(a) is a view showing a condition in which a banknote reception unit 121a is mounted on a first inlet unit 121, and FIG. 4(b) is a view showing a condition in which an interface cassette 37 is mounted on the first inlet unit 121. In addition, FIG. 5 shows a functional block view of the banknote handling apparatus shown in FIG. 4.

The structure of the banknote handling apparatus 36 is described in detail with reference to FIGS. 3 to 5. A right side surface of the banknote handling apparatus 36 shown in FIG. 4 faces the inside of the service counter 32 of the customer service area 30 shown in FIG. 1, i.e., the clerk side. On the other hand, a left side surface of the banknote handling apparatus shown in FIG. 4 faces the outside of the service counter 32 of the customer service area 30 shown in FIG. 1, i.e., the customer side.

As shown in FIGS. 3 to 5, the banknote handling apparatus 36 includes a housing 120a, the first inlet unit 121, a second inlet unit 130, and an outlet unit 122. The first inlet unit 121 faces the inside of the service counter 32 of the customer service area 30 shown in FIG. 1, whereby the first inlet unit 121 is used when a clerk deposits a banknote(s) to the banknote handling apparatus 36.

In more detail, the banknote reception unit 121a is detachably mounted on the first inlet unit 121. When the banknote reception unit 121a is mounted on the first inlet unit 121, the banknote reception unit 121a is configured to receive a banknote(s) from outside the banknote handling apparatus 36, and is configured to feed the banknote(s), one by one, into the housing 120a. As shown in FIG. 4(b), the interface cassette 37, in place of the banknote reception unit 121a, can be mounted on the first inlet unit 121. When the interface cassette 37 is mounted on the first inlet unit 121, a banknote(s) in the interface cassette 37 is fed, one by one, into the housing 120a, by a feeding mechanism disposed inside the interface cassette 37. On the other hand, the second inlet unit 130 faces the outside of the service counter 32 of the customer service area 30 shown in FIG. 1, whereby the second inlet unit 130 is used when a customer himself/herself deposits a banknote(s) to the banknote handling apparatus 36.

As shown in FIG. 4, a transport unit 123 configured to transport a banknote(s) one by one is disposed in the housing 120a of the banknote handling apparatus 36. The first inlet unit 121 is connected to one end 123a of the transport unit 123, while the second inlet unit 130 is connected to the other end 123b of the transport unit 123. When the banknote reception unit 121a or the interface cassette 37 is mounted on the first inlet unit 121, a banknote having been fed out from the banknote reception unit 121a or the interface cassette 37 is transported by the transport unit 123 through the one end 123a of the transport unit 123. On the other hand, a banknote having been inserted by a customer into the second inlet unit 130 is transported by the transport unit 123 through the other end 123b of the transport unit 123.

As shown in FIG. 4, the transport unit 123 is provided with a recognition unit 124. Denomination, fitness, authenticity and so on of each banknote transported by the transport unit 123 are recognized by the recognition unit 124.

In addition, a plurality of storing and feeding units 125 are disposed in the housing 120a. The respective storing and feeding units 125 are connected to the transport unit 123. The respective storing and feeding units 125 are configured to store a banknote(s) by denomination. To be more specific, based on a recognition result by the recognition unit 124, a banknote(s) having been fed to the transport unit 123 from the first inlet unit 121 and the second inlet unit 130 is sent by the transport unit 123 to the respective storing and feeding units 125 by denomination. In addition, the respective storing and feeding units 125 are capable of feeding out, one by one, the banknote(s) stored in the storing and feeding units 125 to the transport unit 123. Each storing and feeding unit 125 may be a storing and feeding unit of a tape reeling type which reels up a pair of tapes between which banknotes are sandwiched one by one, or may be a storing and feeding unit of a stacker type which stores banknotes in a stacked manner (not shown).

A collecting unit 126 is disposed in the housing 120a. The collecting unit 126 is used when a banknote(s) stored in the storing and feeding units 125 is collected. More specifically, a banknote storing pouch (not shown) for storing a banknote(s) can be detachably set in the collecting unit 126. Thus, a banknote(s) sent from the storing and feeding unit 125 to the collecting unit 126 through the transport unit 123 is stored into the banknote storing pouch. In addition, a banknote(s) of a denomination that is not assigned to any of the storing and feeding units 125, and an overflow banknote(s) which cannot be stored into the storing and feeding unit 125 of the corresponding denomination because it is full, are stored into the banknote storing pouch of the collecting unit 126. By taking out the banknote storing pouch from the collecting unit 126, a banknote(s) stored in the banknote storing pouch is collected from the banknote handling apparatus 36.

In addition, as shown in FIG. 4, the banknote handling apparatus 36 is provided with a first apparatus-external reject unit 127, a second apparatus-external reject 132 and an apparatus-internal reject unit 128.

A banknote, which has been recognized as not a normal banknote by the recognition unit 124 out of banknotes taken into the housing 120a by the first inlet unit 121 or the second inlet unit 130, is sent as a reject banknote to the first apparatus-external reject unit 127 or the second apparatus-external reject unit 132. The reject banknote(s) is dispensed outside the banknote handling apparatus 36 by these first apparatus-external reject unit 127 and the second apparatus-external reject unit 132.

In more detail, as shown in FIG. 4, the first apparatus-external reject unit 127 faces the inside of the service counter 32 of the customer service area 30 shown in FIG. 1. When there is a reject banknote in banknotes deposited from the first inlet unit 121, the reject banknote is sent to the first apparatus-external reject unit 127 and is collected by a clerk. In addition, the second apparatus-external reject unit 132 faces the outside of the service counter 32 of the customer service area 30 shown in FIG. 1. When there is a reject banknote in banknotes deposited from the second inlet unit 130, the reject unit is sent to the second apparatus-external reject unit 132 and is collected by a customer. Meanwhile, a reject banknote that cannot be dispensed outside the banknote handling apparatus 36 is sent to the apparatus-internal reject unit 128 from the transport unit 123. The apparatus-internal reject unit 128 is configured to store such a reject banknote. An operator who does not have a management authority, such as a customer, a clerk and so on, cannot take out the banknote in the apparatus-internal reject unit 128.

In addition, as shown in FIGS. 3 and 5, the banknote handling apparatus 36 is provided with an operation display unit 140. The operation display unit 140 is formed of a display of a touch panel type, for example. The display faces the outside of the service counter 32 of the customer service area 30 shown in FIG. 1, i.e., the customer side. The operation display unit 140 is configured such that a customer can input therethrough various instructions and can see information displayed on the operation display unit 140. The orientation of the operation display unit 140 can be freely varied. Thus, by turning the operation display unit 140 to face the inside of the service counter 32 of the customer service area 30, i.e., the clerk side, a clerk may input therethrough various instructions and may see information displayed on the operation display unit 140.

In addition, the banknote handling apparatus 36 is provided with a printing unit 142. The printing unit 142 is formed of a printer, for example, and is configured to print a voucher such as a cash voucher or the like. As shown in FIG. 4, the printing unit 142 has a printed-matter outlet opening 142a. A voucher printed by the printing unit 142 is dispensed outside the printing unit 142 from the printed-matter outlet opening 142a. In this embodiment, the printed-matter outlet opening 142a of the printing unit 142 faces the outside of the service counter 32 of the customer service area 30 shown in FIG. 1. A voucher, which has been dispensed outside the printing unit 142 from the printed-matter outlet opening 142a, can be received by a customer.

In addition, a control unit 170 configured to control respective constituent elements of the banknote handling apparatus 36 is disposed in the housing 120a of the banknote handling apparatus 36. A structure of the control unit 170 is described with reference to FIG. 5. As shown in FIG. 5, the control unit 170 is connected respectively to the first inlet unit 121, the second inlet unit 130, the outlet unit 122, the transport unit 123, the recognition unit 124, the storing and feeding units 125, the collecting unit 126, the operation display unit 140, the printing unit 142 and so on. A banknote recognition result by the recognition unit 124 is transmitted to the control unit 170. The control unit 170 transmits instructions respectively to the first inlet unit 121, the second inlet unit 130, the outlet unit 122, the transport unit 123, the storing and feeding units 125, the collecting unit 126 and the printing unit 142 so as to control these constituent elements. In addition, information having been input by a customer through the operation display unit 140 is transmitted to the control unit 170. The control unit 170 transmits information to the operation display unit 140, so that the operation display unit 140 is caused to display various information.

In addition, as shown in FIG. 5, an interface 172 is connected to the control unit 170. The control unit 170 is capable of transmitting and receiving information to and from an external apparatus (specifically, for example, the higher-level terminal 52 (see FIG. 2)) through the interface 172. In addition, a memory unit 174 is connected to the control unit 170. The memory unit 174 is configured to store various set information of the banknote handling apparatus 36 and storing information of a banknote(s) stored in the respective storing and feeding units 125, such as the number of banknotes for each denomination.

Next, an operation of the banknote handling apparatus as structured above is explained herebelow. The below-described operation of the banknote handling apparatus 36 is performed by the control unit 170 which controls the respective constituent elements of the banknote handling apparatus 36.

An operation for depositing a banknote(s) to the banknote handling apparatus 36 is firstly explained. When a customer desires to convert a banknote(s) in hand into a cash voucher or the like usable in the store in advance, to obtain a cash voucher with premium from the store, a value of which is larger than a deposit amount, or to obtain another service, the customer deposits a banknote(s) to the banknote handling apparatus 36. On the other hand, when a clerk deposits sales proceeds in the service counter 32 and when a clerk deposits a banknote(s) of sales proceeds collected from the banknote depositing and dispensing apparatus 24 of each money settlement apparatus 22 in the settlement corner 20, the clerk deposits a banknote(s) to the banknote handling apparatus 36. When a customer deposits a banknote(s) to the banknote handling apparatus 36, the customer puts a banknote(s) into the second inlet unit 130 facing the outside of the service counter 32 of the customer service area 30 shown in FIG. 1. Then, the banknote is fed, one by one, from the second inlet unit 130 into the housing 120a. On the other hand, when a clerk deposit a banknote(s) directly to the banknote handling apparatus 36, the clerk mounts the banknote reception unit 121a on the first inlet unit 121. Thus, the banknote reception unit 121a receives a banknote(s) from outside the banknote handling apparatus 36 and feeds the banknote, one by one, into the housing 120a. On the other hand, as shown in FIG. 4(b), when a banknote(s) stored in the interface cassette 37 is deposited to the banknote handling apparatus 36, the interface cassette 37 is mounted on the first inlet unit 121. In this case, when the interface cassette 37 is mounted on the first inlet unit 121, the banknote(s) in the interface cassette 37 is automatically fed, one by one, into the housing 120a, by the feeding mechanism provided inside the interface cassette 37.

The banknote(s) having been fed into the housing 120a by the first inlet unit 121 and the second inlet unit 130 is transported by the transport unit 123, and is recognized by the recognition unit 124. A banknote that has been recognized as a normal banknote by the recognition unit 124 is stored into any of the storing and feeding units 125 by denomination. On the other hand, a banknote that has been recognized as a normal banknote by the recognition unit 124 is sent to the collecting unit 126, when the storing and feeding unit 125 corresponding to a denomination of the banknote is full or when a denomination of the banknote is not assigned to any of the storing and feeding units 125. In addition, a banknote that has been recognized as not a normal banknote (e.g., a counterfeit note or the like) and/or a banknote that could not be recognized by the recognition unit 124 is sent as a reject banknote to the first apparatus-external reject unit 127, the second apparatus-external reject unit 132 or the apparatus-internal reject unit 128, depending on setting.

In addition, a total amount of money of a banknote(s) having been taken into the apparatus body of the banknote handling apparatus 36 is calculated by the control unit 170. In this manner, after all the banknotes have been fed into the housing 120a from the first inlet unit 121 and the second inlet unit 130, all the banknotes are stored into the respective storing and feeding units 125, the collecting unit 126 and so on, and then the banknote depositing process in the banknote handling apparatus 36 is finished. In a case where a customer deposits a banknote(s) to the banknote handling apparatus 36, after the banknote depositing process in the banknote handling apparatus 36 has been finished, a voucher such as a cash voucher or the like is printed by the printing unit 142, and the printed voucher is dispensed outside the printing unit 142 from the printed-matter outlet opening 142a, as described below. In this manner, the customer can receive the voucher such as the cash voucher or the like.

Next, an operation for dispensing a banknote(s) from the banknote handling apparatus 36 is explained. Specifically, when banknote change funds are replenished into the banknote depositing and dispensing apparatus 24 of the money settlement apparatus 22 before opening hours of a store, the banknote handling apparatus 36 creates a predetermined pattern of banknote change funds, and dispenses the same. To be more specific, when the banknote change funds are prepared in the banknote handling apparatus 36, the interface cassette 37 is mounted on the first inlet unit 121 so that a banknote(s) having been fed out from the respective storing and feeding units 125 is stored into the interface cassette 37. At this time, the one end 123a of the transport unit 123 also serves as an outlet opening from which a banknote(s) is dispensed outside the apparatus body. When the banknote handling apparatus 36 prepares the banknote change funds, the control unit 170 controls the respective constituent elements of the banknote handling apparatus 36, such that a banknote(s) is fed out from the respective storing and feeding units 125 and that the fed-out banknote is sent to the interface cassette 37 mounted on the first inlet unit 121, based on a dispensing pattern of banknote change funds (specifically, a number pattern of banknote(s) by denomination). Information related to the dispensing pattern of change funds is stored in the memory unit 174 in advance, input by a clerk or the like to the control unit 170 through the operation display unit 140, or transmitted to the control unit 170 from the higher-level terminal 52 through the interface 72.

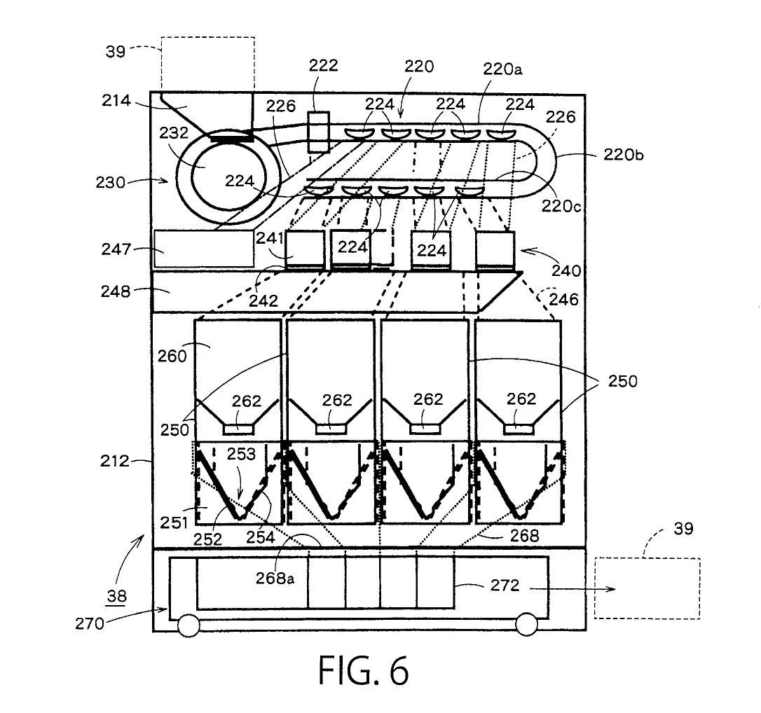

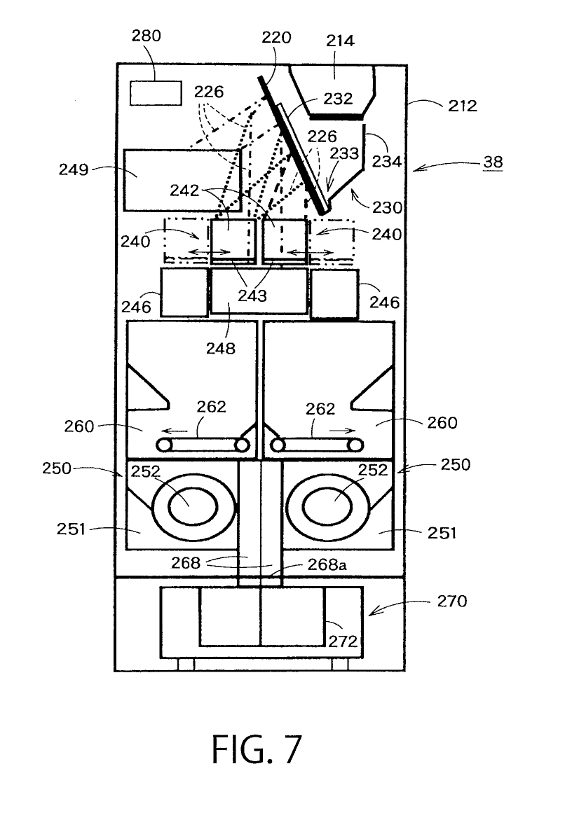

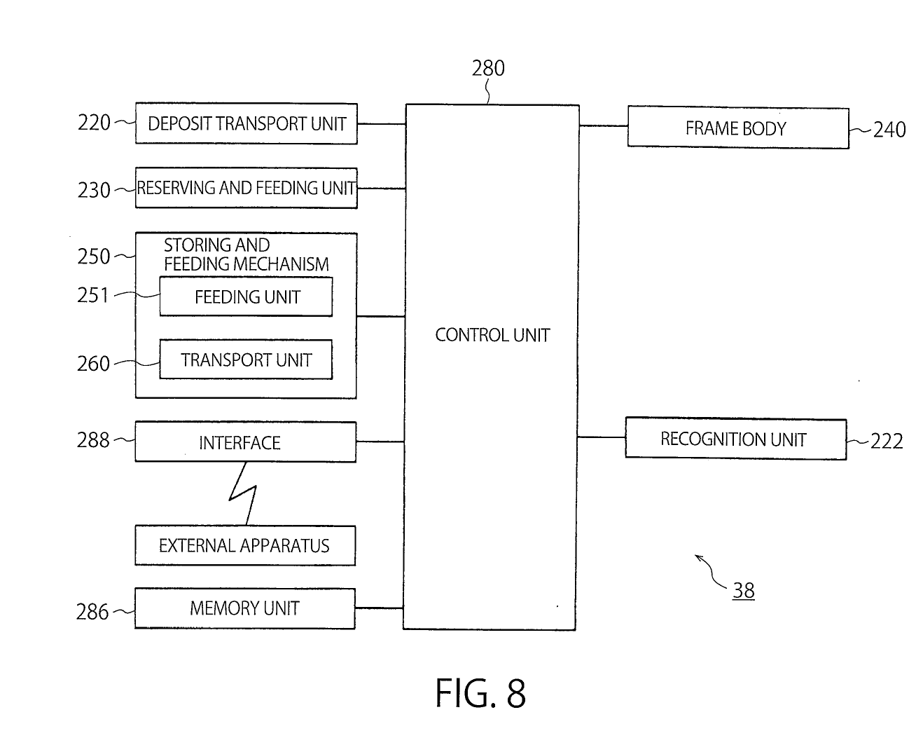

Next, a structure of the coin handling apparatus 38 in the money handling apparatus 34 is explained in detail with reference to FIGS. 6 to 8. FIG. 6 is a side view schematically showing an inside structure of the coin handling apparatus 38. FIG. 7 is a front view of the coin handling apparatus 38 shown in FIG. 6. In addition, FIG. 8 is a functional block view of the coin handling apparatus 38 shown in FIGS. 6 and 7. A right side surface of the coin handling apparatus 38 shown in FIG. 6 faces the inside of the service counter 32 of the customer service area 30 shown in FIG. 1, while a left side surface of the coin handling apparatus 38 shown in FIG. 6 faces the outside of the service counter 32 of the customer service area 30 shown in FIG. 1.

As shown in FIGS. 6 and 7, the coin handling apparatus 38 includes a housing 212 of a substantially parallelepiped shape, a coin reception opening 214 configured to receive a coin(s) from outside the housing 212, and a reserving and feeding mechanism 230 configured to reserve (store) a coin(s) having been received in the coin inlet unit 214 and to feed the reserved coin(s) one by one. In the housing 212, there is disposed a deposit transport unit 220 configured to transport, one by one, a coin(s) having been fed out from the reserving and feeding mechanism 230. The deposit transport unit 220 is provided with a recognition unit 222 configured to recognize a coin transported by the deposit transport unit 220, and a selection unit 224 configured to select a coin based on a coin recognition result by the recognition unit 222.

In addition, as shown in FIG. 7, a pair of right and left escrow units 240 are disposed below the deposit transport unit 220 in the housing 212. A coin(s) selected by the selection unit 224 is escrowed in these escrow units 240, in such a manner that the coin is classified by denomination. In addition, a plurality of (specifically, eight) storing and feeding mechanisms 250 are disposed below the escrow units 240. Each of the storing and feeding mechanisms 250 is configured to store a coin that has been escrowed in the escrow units 240 and sent thereto. In addition, each of the storing and feeding mechanisms 250 is configured to feed out, one by one, the coin(s) stored in the storing and feeding mechanism 250.

In addition, as shown in FIGS. 6 and 7, a collecting box 270 is disposed below the respective storing and feeding mechanisms 250 in the housing 212. A drawer 272 is detachably provided on the collecting box 270. A coin(s) having been fed out from the respective storing and feeding mechanisms 250 is stored into the drawer 272 mounted on the collecting box 270, in such a manner that the coin is classified by denomination. In the register system 21 of the settlement corner 20, when a drawer storage is used in place of the coin depositing and dispensing apparatus 26 or in addition to the coin depositing and dispensing apparatus 26, the drawer 272 detachably mounted on the collecting box 270 can be used as the drawer storage of the register system 21 of the settlement corner 20. Alternatively, in place of the drawer 272, a below-described coin storing cassette 39 may be mounted on the collecting box 270.

In addition, in the housing 212 of the coin handling apparatus 38, there is disposed a control unit 280 configured to control respective constituent elements of the coin handling apparatus 38.

Details of the respective constituent elements of the coin handling apparatus 38 as structured above is explained herebelow.

As shown in FIGS. 6 and 7, the coin reception opening 214 configured to receive a coin(s) put thereinto from outside the housing 212 is located in an upper part of the housing 212, so that a coin received by the coin reception opening 214 is sent to the reserving and feeding mechanism 230 by its own weight. The coin reception opening 214 is located in the housing 212 at a position near to the outside surface of the service counter 32 of the customer service area 30, i.e., at a position near to the customer-side surface. Thus, a customer can reliably put a coin(s) into the coin reception opening 214 of the coin handling apparatus 38 installed in the service counter 32 of the customer service area 30.

In addition, a coin storing cassette 39 can be detachably attached to the coin reception opening 214. When the coin storing cassette 39 is attached to the coin reception opening 214, a coin(s) stored into the coin storing cassette 39 is sent to the coin reception opening 214.

The reserving and feeding mechanism 230 includes a rotation disk 232 that is inclined at a predetermined angle relative to the vertical direction and is configured to be rotated in an inclined posture, and a cover member 234 that forms a coin reserving space 233 for reserving a coin between the cover member 234 and a surface of the rotation disk 232. A rotation shaft (not shown) is attached to the rotation disk 232. The rotation disk 232 is configured to be rotated about the rotation shaft in such a condition that the rotation disk 232 is inclined at the predetermined angle relative to the vertical direction. In addition, a plurality of projection members (not shown) are disposed on the surface of the rotation disk 232 on the side of the coin reserving space 233. These projection members are located at positions near to a peripheral portion of the rotation disk 232, with equal intervals therebetween along the peripheral portion. Since the respective projection members are configured to catch a coin(s) on the surface of the rotation disk 232, a coin(s) in a lower area of the rotation disk 232 is transported to an upper area of the rotation disk 232 by the rotation of the rotation disk 232.

In addition, in the reserving and feeding mechanism 230, a transport belt (not shown) is disposed in the upper area of the rotation disk 232. The transport belt is configured to transport a coin, which has been transported by the projection members from the lower area of the rotation disk 232 to the upper area thereof, outside the coin reserving space 233. To be specific, the coin is sent from the coin reserving space 233 in the reserving and feeding mechanism 230 to the deposit transport unit 220.

A coin(s) having been fed out from the reserving and feeding mechanism 230 is transported, one by one, by the deposit transport unit 220. As shown in FIG. 6, the deposit transport unit 220 has: an upper transport section 220 extending along substantially the horizontal direction; a turnback transport section 220b configured to transport a coin having been sent from the upper transport section 220a in such a manner that a coin transport direction is reversed; and a lower transport section 220c disposed below the upper transport section 220a to extend along substantially the horizontal direction, and configured to transport the coin having been sent from the turnback transport section 220b. A coin having been fed out from the reserving and feeding mechanism 230 is transported to the upper transport section 220a, the turnback transport section 220b and the lower transport section 220c, in this order. The recognition unit 222 is disposed on the upper transport section 220a. The recognition unit 222 is configured to recognize denomination, authenticity and so on of a coin having been fed out from the reserving and feeding mechanism 230. In addition, the upper transport section 220a and the lower transport section 220c are respectively provided with a plurality of selection units 224 configured to select a coin based on a coin recognition result by the recognition unit 222.

Based on a coin recognition result by the recognition unit 222, the respective selection units 224 disposed on the upper transport section 220a are configured to select a coin(s) transported by the upper transport section 220a to send the coin(s) to a reject unit 247, an overflow box 249, which are described below, or the escrow unit 240.

In the coin handling apparatus 38 in this embodiment, the pair of right and left escrow units 240 are disposed (see FIG. 7). The respective escrow units 240 are configured to escrow a coin(s), in such a manner that the coin is classified by denomination. The coin(s) escrowed in each escrow units 240 is sent selectively to a return box 248 or to the respective storing and feeding mechanisms 250. The return box 248 is structured so as to be drawable from the inside of the housing 212 to the outside thereof. By drawing the return box 248 to the outside of the housing 212, an operator can take out a coin(s) in the return box 248. Namely, the return box 248 is used for returning a coin(s) escrowed in the escrow units 240 to the outside of the housing 212. Each of the escrow units 240 is movable between a first position shown by the solid line in FIG. 7, and a second position shown by the two-dot chain lines in FIG. 7. When the escrow unit 240 is located on the first position, the escrow unit 240 is configured to receive a coin(s) having been selected by the respective selection units 224. On the other hand, when the escrow unit 240 is moved from the first position to the second position, a coin(s) escrowed in the escrow unit 240 is sent to the respective storing and feeding mechanisms 250.

In more detail, as shown in FIG. 7, each escrow unit 240 includes a frame body 242 having a top opening and a bottom opening, and a bottom plate 243 configured to selectively close the bottom opening of the frame body 242. The frame body 242 and the bottom plate 243 are movable independently of each other, between the first position shown by the solid line in FIG. 7, and the second position shown by the two-dot chain lines in FIG. 7. As shown in FIG. 7, the return box 248 is located on a position directly below the frame body 242 at the first position. On the other hand, a plurality of chutes 246 are located on positions directly below the frame body 242 at the second position. The chutes 246 are in communication with the respective storing and feeding mechanisms 250 of corresponding denominations.

When the frame body 242 and the bottom plate 243 are located respectively on the first positions, the escrow unit 240 receives a coin(s), which has been selected by the selection units 224 of the deposit transport unit 220 and sent to the escrow unit 240 through the chute 226, through the top opening of the frame body 242. At this time, since the bottom opening of the frame body 242 is closed by the bottom plate 243, the coin(s) sent to the escrow unit 240 is escrowed in the escrow unit 240. When the frame body 242 is moved from the first position to the second position while the bottom plate 243 is maintained on the first position, the coin(s) escrowed in the escrow unit 240 falls down by its own weight through the bottom opening of the escrow unit 240, so as to be sent to the storing and feeding mechanism 250 through the chute 246 by denomination. On the other hand, when the bottom plate 243 is moved from the first position to the second position while the frame body 242 is maintained on the first position, the coin(s) escrowed in the escrow unit 240 is sent to the return box 248.

As shown in FIGS. 6 and 7, each storing and feeding mechanism 250 includes a feeding unit 251 configured to feed out a coin(s), and a transport unit 260 configured to store a coin(s) having been sent from the respective escrow units 240 and to transport the stored coin(s) to the feeding unit 251. The feeding unit 251 of each storing and feeding mechanism 250 includes a rotation disk 252 that is inclined at a predetermined angle relative to the vertical direction and is configured to be rotated in an inclined posture, and a cover member 254 that forms a coin storing space 253 for storing a coin between the cover member 254 and a surface of the rotation disk 252. On the surface of the rotation disk 252, there are provided a plurality of projection members (not shown) projecting from the surface. During the rotation of the rotation disk 252, a coin(s) is brought from a lower area of the rotation disk 252 to an upper area thereof in such a manner that the coin(s) is held one by one between the projection member and the cover member 254, so that the coin(s) is pushed toward an outlet opening (not shown) of the storing and feeding mechanism 250.

The transport unit 260 of each storing and feeding mechanism 250 has an endless transport belt 262 extending in substantially the horizontal direction. Coins having been sent from the respective escrow units 240 are stacked on the transport belt 262. When the transport belt 262 is circulated in a direction shown by the arrow in FIG. 7, the coins stacked on the transport belt 262 become loose, and the coins are sent to the coin storing space 253 formed between the rotation disk 252 and the cover member 254 of the feeding unit 251. The transport belt 262 of the transport unit 260 and the rotation disk 252 of the feeding unit 251 are synchronically operated.

A coin(s) having been fed out from the respective storing and feeding mechanisms 250 is stored into the drawer 272 or the coin storing cassette 39 mounted on the collecting box 270 (described below), through the chute 268 corresponding to the storing and feeding mechanism 250.

As shown in FIGS. 6 and 7, the collecting box 270 is detachably provided in a lower part of the housing 212 of the coin handling apparatus 38. As shown by the arrow in FIG. 6, the collecting box 270 can be drawn rightward in FIG. 6 from the surface of the housing 212 inside the service counter 32 of the customer service area 30, i.e., from the clerk-side surface. When the collecting box 270 is drawn from the housing 212, the drawer 272 or the coin storing cassette 39 can be taken out from the collecting box 270. Thereafter, the drawer 272 or the coin storing cassette 39 is transported by a clerk or the like to the settlement corner 20. A coin(s) stored in the coin storing cassette 39 is manually stored as change funds into the coin depositing and dispensing apparatus 26 of the coin settlement apparatus 22.

In addition, the coin handling apparatus 38 in this embodiment is provided with a control unit 280 configured to control respective constituent elements of the coin handling apparatus 38. FIG. 8 is a functional block view of the coin handling apparatus 38 shown in FIGS. 6 and 7. A structure of the control unit 280 is explained with reference to FIG. 8.

As shown in FIG. 8, the control unit 280 is connected to the deposit transport unit 220, the recognition unit 222, the reserving and feeding mechanism 230, the respective escrow units 240, the feeding unit 251 of the storing and feeding mechanism 250, the transport unit 260 thereof and so on. The control unit 280 is configured to transmit and receive signals to and from these constituent elements.

To be more specific, a signal related to a coin recognition result by the recognition unit 222 is transmitted to the control unit 280. In addition, the control unit 280 transmits signals to the deposit transport unit 220, the reserving and feeding mechanism 230, the escrow units 240, the feeding unit 251 of the storing and feeding mechanism 250, the transport unit 260 thereof and so on, so as to control these constituent elements.

In addition, a memory unit 286 is connected to the control unit 280. The memory unit 286 is configured to store information such as various settings of the coin handling apparatus 38, a coin process result by the coin handling apparatus 38 and so on. Specifically, information related to a setting of denominations of coins selected by the respective selection units 224 disposed on the deposit transport unit 220, and information such as the number of and an amount of coin(s) by denomination stored in the respective storing and feeding units 250, are stored in the memory unit 286.

In addition, an interface 288 is connected to the control unit 280. The control unit 280 is capable of transmitting and receiving a signal to and from an external apparatus (e.g., higher-level terminal 52) of the coin handling apparatus 38 through the interface 288.

Next, an operation of the coin handling apparatus 38 as structured above is explained. In the coin handling apparatus 38, mainly, a customer deposits a coin(s) thereto. Similarly to the banknote handling apparatus 36, when a customer desires to convert a coin(s) in hand into a cash voucher or the like usable in the store in advance, to obtain a cash voucher with premium from the store, a value of which is larger than a deposit amount, or to obtain another service, the customer deposits a coin(s) to the coin handling apparatus 38. The below-described operation of the coin handling apparatus 38 is performed by the control unit 280 which controls the respective constituent elements of the coin handling apparatus 38.

When a customer puts a coin(s) into the coin reception opening 214 of the coin handling apparatus 38, the coin falls down by its own weight to be sent to the reserving and feeding mechanism 230. In the reserving and feeding mechanism 230, the rotation disk 232 is rotated clockwise in FIG. 6. Thus, the coin reserved in the coin reserving space 233 and being in the lower area of the rotation disk 232 is caught by the respective projection members (not shown) on the surface of the rotation disk 232, so as to be transported, one by one, to the upper area of the rotation disk 232, by the rotation of the rotation disk 232. Then, the coin having been transported to the upper area of the rotation disk 232 is fed out from the reserving and feeding mechanism 230.

The coin having been fed out from the reserving and feeding mechanism 230 is transported by the upper transport section 220a of the deposit transport unit 220. At this time, denomination, authenticity and so on of the coin are recognized by the recognition unit 222. Then, based on the coin recognition result by the recognition unit 222, the coin transported by the upper transport section 220a is selected by the respective selection units 224 disposed on the upper transport section 220a, and is sent to the reject unit 247, the overflow box 249 or the escrow unit 240.

A coin that has not been selected by any of the selection units 224 in the upper transport section 220a is sent to the turnback transport section 220b. Then, in the turnback transport section 220b, the coin falls down by its own weight to be transported from the upper transport section 220a to the lower transport section 220c.

In the lower transport section 220c, the coin is transported leftward in FIG. 6. The coin transported by the lower transport section 220c is sent by denomination by the respective selection units 224 to the escrow unit 240 through the respective chutes 226. After the coin has been escrowed in the escrow unit 240, when the customer gives a deposit confirmation instruction to the control unit 280 through the operation display unit 140, the frame body 242 of the escrow unit 240 is moved from the first position (solid line in FIG. 7) to the second position (tow-dot chain lines in FIG. 7). At this time, the bottom plate 243 remains to be maintained on the first position (solid line in FIG. 7). Thus, the coin escrowed in the escrow unit 240 falls down by its own weight through the bottom opening (not shown), so as to be sent by denomination to the storing and feeding mechanism 250 through the chute 246. On the other hand, after the coin has been escrowed in the escrow unit 240, when the customer gives a coin return instruction to the control unit 280 through the operation display unit 140, the bottom plate 243 of the escrow unit 240 is moved from the first position (solid line in FIG. 7) to the second position (two-dot chain lines in FIG. 7). At this time, the frame body 242 remains to be maintained on the first position (solid line in FIG. 7). Thus, the coin escrowed in the escrow unit 240 falls down by its own weight, so as to be sent to the return box 248. The customer can receive the returned coin, by drawing the return box 248 from the housing 212 toward himself/herself.

Coins having been sent by denomination to the respective storing and feeding mechanisms 250 from the respective escrow units 240 are stacked on the transport belt 262 of the transport unit 260. Then, when the transport belt 262 is circulated in the direction shown by the arrow in FIG. 7, the coins stacked on the transport belt 262 become loose, and the coins are sent to the coin storing space 253 formed between the rotation disk 252 and the cover member 254 of the feeding unit 251. In this manner, coins are stored into the respective storing and feeding mechanisms 250. In addition, at this time, a total amount of money of the coins taken into the apparatus body of the coin handling apparatus 38 is calculated by the control unit 280. In a case where the customer deposits a coin(s) to the coin handling apparatus 38, a voucher such as a cash voucher is printed by the printing unit 142 of the banknote handling apparatus 36, after the coin deposit process in the coin handling apparatus 38 has been finished. The printed voucher is dispensed from the printed-matter outlet opening 142a to the outside of the printing unit 142. In this manner, the customer can receive a voucher such as a cash voucher.

Next, an operation for dispensing a coin from the coin handling apparatus 38 is explained. Specifically, similarly to the case of the banknote handling apparatus 36, when coin change funds are replenished into the coin depositing and dispensing apparatus 24 of the money settlement apparatus 22 before opening hours of a store, a predetermined pattern of coin change funds is created and a coin(s) is dispensed to the coin depositing and dispensing apparatus 24. When the number of coins increases too much in the coin depositing and dispensing apparatus 24, a dispensing operation for collecting coin(s) is performed. When a clerk dispenses or collects coins from the coin handling apparatus 38, coins stored in the storing and feeding mechanism 250 corresponding to a denomination to be dispensed or collected are fed out therefrom, and the fed-out coins are stored into the drawer 272 or the coin storing cassette 39 attached to the collecting box 270. Specifically, in order that the coins are dispensed from the coin handling apparatus 38, the drawer 272 or the coin storing cassette 39 is attached to the collecting box 270, and the collecting box 270 is mounted on the housing 212 together with the drawer 272 or the coin storing cassette 39.

Due to the rotation of the rotation disk 252 in the storing and feeding mechanism 250, a coin(s) reserved in the coin reserving space 253 and being in the lower area of the rotation disk 252 is caught by the respective projection members (not shown) on the surface of the rotation disk 252, so that the coin(s) is transported, one by one, to the upper area of the rotation disk 252, by the rotation of the rotation disk 252. The coin having been transported to the upper area of the rotation disk 252 is fed out from the storing and feeding mechanism 250. Then, the coin falls down by its own weight in the chute 268, so as to be stored into the drawer 272 or the coin storing cassette 39 attached to the collecting box 270. At this time, a lower end 268a of the chute 268 serves as an outlet opening through which the coin is dispensed outside the apparatus body. Thereafter, as shown by the arrow in FIG. 6, the collecting box 270 is drawn rightward in FIG. 6 from the surface of the housing 212 inside the service counter 32 of the customer service area 30, i.e., from the clerk-side surface. In this manner, when the collecting box 270 is drawn out from the housing 212, the drawer 272 or the coin storing cassette 39 is taken out from the collecting box 270. Thereafter, the drawer 272 or the coin storing cassette 39 is transported to the settlement corner 20 by a clerk or the like. Then, the coin(s) stored in the coin storing cassette 39 is stored as change funds into the coin depositing and dispensing apparatus 26 of the money settlement apparatus 22.

In the money handling apparatus 34 composed of the aforementioned banknote handling apparatus 36 and the aforementioned coin handling apparatus 38, when a customer converts a banknote(s) and/or a coin(s) in hand to a voucher such as a cash voucher or the like, the customer puts a banknote(s) into the second inlet unit 130 of the banknote handling apparatus 36 and/or puts a coin(s) into the coin reception opening 214 of the coin handling apparatus 38. In this embodiment, the second inlet unit 130 of the banknote handling apparatus 36 and the coin reception opening 214 of the coin handling apparatus 38 face the outside of the service counter 32 of the customer service area 30 shown in FIG. 1. Then, the banknote(s) and the coin(s) having been put into the apparatus body by the customer are stored by denomination into the respective storing and feeding units 125 of the banknote handling apparatus 36 and the respective storing and feeding mechanisms 250 of the coin handling apparatus 38. At this time, a total amount of the banknote(s) having been taken into the apparatus body is calculated by the control unit 170 of the banknote handling apparatus 36 and a total amount of the coin(s) having been taken into the apparatus body is calculated by the control unit 280 of the coin handling apparatus 38. Then, a voucher such as a cash voucher or the like, whose value is equivalent to the total amount of the banknote(s) and the coin(s), which has been calculated by the control unit 170 and the control unit 280, is printed by the printing unit 142, and the printed voucher such as a cash voucher is dispensed outside the printing unit 142 through the printed-matter outlet opening 142a. In this embodiment, the printed-matter outlet opening 142a of the printing unit 142 faces the outside of the service counter 32 of the customer service area 30 shown in FIG. 1. Thus, the voucher having been dispensed outside the printing unit 142 from the printed-matter outlet opening 142a can be reliably received by the customer.

On the other hand, the money handling apparatus 34 in this embodiment can recycle a banknote(s) stored in the respective storing and feeing units 125 of the banknote handling apparatus 36 and a coin(s) stored in the respective storing and feeding mechanisms 250 of the coin handling apparatus 38. To be specific, when a banknote(s) and/or a coin(s) as change funds are replenished into the banknote depositing and dispensing apparatus 24 and/or the coin depositing and dispensing apparatus 26 of the money settlement apparatus 22 installed in the settlement corner 20, a clerk or the like causes a banknote(s) stored in the respective storing and feeding units 125 of the banknote handling apparatus 36 and/or a coin(s) stored in the respective storing and feeding mechanisms 250 of the coin handling apparatus 38 to be dispensed from the banknote handling apparatus 36 and/or the coin handling apparatus 38. In more detail, in the banknote handling apparatus 36, the interface cassette 37 is mounted on the first inlet unit 121. Then, based on a dispensing instruction given to the control unit 170, a banknote(s) that has been fed out from the respective storing and feeding units 125 is stored into the interface cassette 37. Then, the interface cassette 37 is transported to the settlement corner 20 by a clerk or the like, and the banknote(s) therein is stored as change funds into the banknote depositing and dispensing apparatus 24 of the money settlement apparatus 22. In addition, in the coin handling apparatus 38, the collecting box 270, to which the drawer 272 or the coin storing cassette 39 is attached, is mounted on the housing 212. Then, based on a dispensing instruction given to the control unit 280, a coin(s) stored in the respective storing and feeding mechanisms 250 is fed out from the storing and feeding mechanisms 250 so as to be stored into the drawer 272 or the coin storing cassette 39 attached to the collecting box 270. Thereafter, as shown by the arrow in FIG. 6, the collecting box 270 is drawn rightward in FIG. 6 from the surface of the housing 212 inside the service counter 32 of the customer service area 30, i.e., from the clerk-side surface. In this manner, the collecting box 270 is drawn out from the housing 212, and the drawer 272 or the coin storing cassette 39 is taken out from the collecting box 270. Following thereto, the drawer 272 or the coin storing cassette 39 is transported to the settlement corner 20 by a clerk or the like. Then, the coin(s) stored in the coin storing cassette 39 is manually stored as change fund(s) into the coin depositing and dispensing apparatus 26 of the money settlement apparatus 22.

As described above, according to the money handling apparatus 34 in this embodiment, there are provided the second inlet unit 130 and the coin reception opening 214 into which a customer himself/herself can put a banknote(s) and a coin(s), and a total amount of money of a banknote(s) and/or a coin(s), which have been put by a customer through the second inlet unit 130 and/or the coin reception opening 214 so as to be taken into into the apparatus body, is calculated by the control unit 170 of the banknote handling apparatus 36 and/or the control unit 280 of the coin handling apparatus 38. In addition, a voucher such as a cash voucher, whose value is equivalent to the total amount of the banknote(s) and/or the coin(s), which has been calculated by the control units 170 and/or 280, is dispensed from the printed-matter outlet opening 142a of the printing unit 142. Further, based on dispensing instructions given to the control units 170 and/or 280, a banknote(s) and/or a coin(s) stored in the respective storing and feeding units 125 and/or the respective storing and feeding mechanisms 250 are dispensed, as many as needed, outside the apparatus body from the one end 123a of the transport unit 123 and/or the lower end 268a (outlet opening) of the chute 268. Thus, the banknote(s) and the coin(s) having been put into the apparatus body by the customer in order to obtain a voucher can be dispensed, whereby the banknote(s) and the coin(s) having been put into the apparatus body of the money handling apparatus 34 can be effectively used by recycling, and the number of times at which an operator or the like of an armoured car company collects the banknote(s) and the coin(s) stored in the apparatus body of the money handling apparatus 34 can be decreased.

In addition, as described above, the money handling apparatus 34 in this embodiment is installed in the customer service area 30, and the dispensing instructions given to the control units 170 and 280 are instructions for dispensing a banknote(s) and a coin(s) as change funds to be replenished into the money settlement apparatus 22 of the register system 21 installed in the settlement corner 20.

In addition, in the money handling apparatus 34 in this embodiment, the interface cassette 37 can be mounted on and removed from the banknote depositing and dispensing apparatus 24 of the money settlement apparatus 22 and the banknote handling apparatus 36. In the banknote handling apparatus 36, a banknote is dispensed to the interface cassette 37 through the one end 123a (outlet opening) of the transport unit 123. In addition, when a drawer storage is disposed on the register system 21, in the coin handling apparatus 38, a coin is dispensed to the drawer 272 used in the drawer storage through the lower end 268a (outlet opening) of the chute 268.

In addition, in the money handling apparatus 34 in this embodiment, the second inlet unit 130, the coin reception opening 214, the printed-matter outlet opening 142a of the printing unit 142 are on the customer side, so that a customer himself/herself can access them. On the other hand, the first inlet unit 121 adjacent to the one end 123a (outlet opening) of the transport unit 123 is located in the service counter 32 of the customer service area 30, whereby a customer cannot access the first inlet unit 121 and the one end 123a of the transport unit 123.

In addition, in the money handling apparatus 34 in this embodiment, the dispensing instructions given to the control unit 170 of the banknote handling apparatus 36 and the control unit 280 of the coin handling apparatus 38 may be given by a clerk or the like through the operation display unit 140. Alternatively, such dispensing instructions may be given from the higher-level terminal 52 to which the money handling apparatus 34 is communicably connected.

The money handling apparatus according to the present invention is not limited to the above embodiment, and can be variously modified.

For example, the money settlement apparatus 22 provided on the register system 21 of the settlement corner 20 may have the following structure. Namely, each of the banknote depositing and dispensing apparatus 24 and the coin depositing and dispensing apparatus 26 of the money settlement apparatus 22 may include: an inlet opening into which a customer himself/herself can put a banknote(s) and a coin(s); a control unit configured to calculate a total amount of the banknote(s) and the coin(s) having been put into the inlet opening by the customer so as to be taken into the apparatus body; and an printed-matter outlet opening through which a voucher such as a cash voucher whose value is equivalent to the total amount of the banknote(s) and the coin(s), which has been calculated by the control unit, is dispensed outside the apparatus body. In such a money settlement apparatus 22, the inlet opening, a medium outlet opening and an outlet opening are located on the customer side, whereby a customer himself/herself can access them. Namely, the register system 21 on which such a money settlement apparatus 22 is provided is of a semi-self type. In this type of money settlement apparatus 22, a clerk only scans an article(s) by a scanner, and a customer himself/herself deposits a banknote(s) and/or a coin(s) to the money settlement apparatus 22 in a settlement process, and the customer himself/herself takes out a banknote(s) and/or a coin(s) dispensed as change from the outlet opening of the money settlement apparatus 22.

In such a money settlement apparatus 22, based on a dispensing instruction given to the control unit of the money settlement apparatus 22, a banknote(s) and/or a coin(s) stored in the apparatus body are dispensed, as many as needed, outside the apparatus body. Namely, similarly to the money handling apparatus 34 installed in the customer service area 30, such a money settlement apparatus 22 can dispense a banknote(s) and a coin(s), which have been put into the apparatus body by a customer in order to obtain a voucher, whereby the banknote(s) and the coin(s) having been put into the apparatus body of the money settlement apparatus 22 can be effectively used by recycling, and the number of times at which an operator or the like of an armoured car company collects the banknote(s) and the coin(s) stored in the apparatus body of the money settlement apparatus 22 can be decreased.

In addition, in this case, the control unit of the money settlement apparatus 22 is configured to execute any one of a settlement mode in which a settlement process is performed, and a charge mode in which a banknote(s) and/or a coin(s) are deposited into the apparatus body, and an indication of the amount of money equivalent to a total amount of the deposited banknote(s) and/or coin(s) is printed on a voucher. In this case, a dispensing instruction given to the control unit is an instruction for dispensing a banknote(s) and/or a coin(s) as change in the settlement mode.

In addition, a dispensing instruction given to the control unit of the money settlement apparatus 22 may be an instruction for dispensing a banknote(s) and/or a coin(s) in a cash-out process when a debit card is received from a customer.

The cash-out process herein means a process in which, when a customer purchases an article(s) of 20 dollars in total, for example, 100 dollars are drawn from a debit card, a banknote(s) and/or a coin(s) of 80 dollars in total are dispensed from the money settlement apparatus 22, and the dispensed banknote(s) and/or coin(s) of 80 dollars in total are handed over the customer.

In addition, the money handling apparatus according to the present invention is not limited to the structure in which a voucher such as a cash voucher whose value is equivalent to a total amount of a banknote(s) and/or a coin(s), which have been deposited into the money handling apparatus, is dispensed from the printed-matter outlet opening. As another embodiment, it is possible that a voucher, which can be used in a company other than the store in which the money handling apparatus is installed, is dispensed from the printed-matter outlet opening, and that a customer receives the voucher. In addition, as still another embodiment, it is possible that an IC card, in which information related to a total amount of a banknote(s) and/or a coin(s) having been deposited into the money handling apparatus is written, is dispensed outside the apparatus body of the money handling apparatus, and that a customer receives the IC card. As further another embodiment, it is possible that an IC card, in which a serial number is written, which corresponds to a total amount of a banknote(s) and/or a coin(s) having been deposited into the money handling apparatus, of a host server such as a POS server 54 in which the total amount is written, is dispensed outside the apparatus body of the money handling apparatus, and that a customer receives the IC card. In addition, it is possible that a paper sheet such as a piece of paper, in which such a serial number is described, is dispensed outside the apparatus body of the money handling apparatus, and that a customer receives the paper sheet. In a case where the money handling apparatus is provided at the settlement corner 20, when the aforementioned charge mode is executed in the control unit, information enabling a value corresponding to a total amount of the deposited money to be specified is stored or recorded in a medium such as a voucher, an IC card and so on.

### DESCRIPTION OF THE SIGNS

10 Store
12 Front area
20 Settlement corner
21 Register system
22 Money settlement apparatus
24 Banknote depositing and dispensing apparatus
26 Coin depositing and dispensing apparatus
28 POS register
30 Customer service area
32 Service counter
34 Money handling apparatus
36 Banknote handling apparatus
37 Interface cassette
38 Coin handling apparatus
39 Coin storing cassette
40 Article rack area
42 Article rack
50 Back office
52 Higher-level terminal
54 POS server
120a Housing
121 First inlet unit
122 Outlet unit
123 Transport unit
123a One end
123b Other end
124 Recognition unit
125 Storing and feeding unit
126 Collecting unit
127 First apparatus-external reject unit
128 Apparatus-internal reject unit
130 Second inlet unit
132 Second apparatus-external reject unit
140 Operation display unit
142 Printing unit
142a Printed-matter outlet opening
170 Control unit
172 Interface
174 Memory unit
212 Housing
214 Coin reception opening
220 Deposit transport unit
220a Upper transport section
220b Turnback transport section
220c Lower transport section
222 Recognition unit
224 Selection unit
226 Chute
230 Reserving and feeding unit
232 Rotation disk
233 Coin reserving space
234 Cover member
240 Escrow unit
242 Frame body
243 Bottom plate
246 Chute
247 Reject unit
248 Return box
249 Overflow box
250 Storing and feeding mechanism
251 Feeding unit
252 Rotation disk
253 Coin reserving space
254 Cover member
260 Transport unit
262 Transport belt
268 Chute
268a Lower end
270 Collecting box
272 Drawer
280 Control unit
286 Memory unit
288 Interface

1. A money handling apparatus to be installed in a store, the money handling apparatus comprising:
an inlet which a customer puts money therein;
a recognition unit configured to recognize and count money having been put into the inlet so as to be taken into an apparatus body;
a plurality of storing units configured to store, by denomination, money having been recognized and counted by the recognition unit;
a control unit configured to calculate a total amount of the money having been put into the inlet by a customer so as to be taken into the apparatus body, based on a recognition result by the recognition unit;
a medium outlet configured to dispense a medium outside the apparatus body, the medium storing or recording information for identifying a value corresponding to the total amount of the money having been calculated by the control unit; and
an outlet configured to dispense money outside the apparatus body;
wherein
based on a dispensing instruction given to the control unit, the money stored in the storing units is dispensed, as much as needed, outside the apparatus body from the outlet.

2. The money handling apparatus according to claim 1, wherein
the medium is any of a voucher that can be used in the store in which the money handling apparatus is installed; a voucher that can be used in a company other than the store in which the money handling apparatus is installed; an IC card in which information related to the total amount of the money calculated by the control unit is written; an IC card in which a serial number, which corresponds to the total amount of money calculated by the control unit, of a host server in which the total amount is written; and a paper sheet in which the serial number is described.

3. The money handling apparatus according to claim 1, wherein
when the money handling apparatus is provided in a settlement corner, the control unit is configured to execute any one of a settlement mode in which a settlement process is performed, and a charge mode in which money is deposited into the apparatus body and the information enabling a value corresponding to a total amount of the deposited money to be specified is stored or recorded in the medium, and
the dispensing instruction given to the control unit is an instruction for dispensing money as change in the settlement mode.

4. The money handling apparatus according to claim 3, wherein
the dispensing instruction given to the control unit is an instruction for dispensing money in a cash-out process when a debit card is received from a customer.

5. The money handling apparatus according to claim 3, wherein the inlet, the medium outlet and the outlet are located on a side of a customer, whereby a customer has access to them.

6. The money handling apparatus according to claim 1, wherein
the money handling apparatus is provided in a customer service area, and
the dispensing instruction given to the control unit is an instruction for dispensing money as change funds to be replenished into a register system installed in a settlement corner.

7. The money handling apparatus according to claim 6, wherein
the money is dispensed to an interface cassette through the outlet, the interface cassette being respectively detachable to the register system and the money handling apparatus.

8. The money handling apparatus according to claim 6, wherein
the money is dispensed to a drawer of the register system through the outlet.

9. The money handling apparatus according to claim 6, wherein
the inlet and the medium outlet are located on a side of a customer, whereby a customer has access to them; and
the outlet is located in a service counter of the customer service area, whereby a customer is incapable of accessing the outlet.

10. The money handling apparatus according to claim 1, wherein
the dispensing instruction is given from a higher-level apparatus to which the money handling apparatus is communicably connected.
